(19) United States
(12) Patent Application Publication
(10) Pub. No.: US 2023/0014356 A1
(43) Pub. Date: Jan. 19, 2023

(54) CONNECTOR AND TERMINAL FITTING

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Tetsuya MIYAMURA, Mie (JP); Yutaka KOBAYASHI, Mie (JP); Daisuke SAITO, Mie (JP); Masanori MORIYASU, Mie (JP); Shinji TANAKA, Mie (JP)

(21) Appl. No.: 17/780,845

(22) PCT Filed: Nov. 11, 2020
(86) PCT No.: PCT/JP2020/041991

§ 371 Date: May 27, 2022

(30) Foreign Application Priority Data
Dec. 2, 2019 (JP) 2019-217841

(51) Int. Cl. H01R 12/72; H01R 13/05

(52) U.S. Cl. CPC H01R 12/72; H01R 13/05

(57) ABSTRACT

A connector is provided with a housing, a circuit board to be arranged along a width direction in a board insertion portion of the housing, and a connecting member to be arranged in the housing and including a contact point portion to be connected to a conductive portion of the circuit board. The connecting member is configured to be swingable in the width direction.

### TECHNICAL FIELD

The present disclosure relates to a connector and a terminal fitting.

### BACKGROUND

A connector described in Patent Document 1 includes a board accommodating member for accommodating a circuit board and a terminal accommodating member for accommodating terminals. When the board accommodating member and the terminal accommodating member are fit, contact portions of the terminals are connected to the circuit board. A connector provided with terminals to be connected to a circuit board is also disclosed in Patent Document 2.

### PRIOR ART DOCUMENT

### Patent Document

Patent Document 1: JP 2017-084570 A

Patent Document 2: JP 2015-090786 A

### SUMMARY OF THE INVENTION

### Problems to be Solved

Terminals and a circuit board are made of different materials and respectively have different thermal expansion coefficients. Thus, if a thermal expansion difference arises between the terminals and the circuit board due to a temperature rise in an installation environment of a connector, a stress for changing the positions of the terminals relative to the circuit board is applied to the terminals. As a result, it may not be possible to maintain a connected state of the terminals and the circuit board.

Accordingly, the present disclosure aims to provide a connector and a terminal fitting capable of ensuring connection reliability with a circuit board.

### Means to Solve the Problem

The present disclosure is directed to a connector with a housing, a circuit board to be arranged along a width direction in the housing, and a connecting member to be arranged in the housing and connected to the circuit board, the connecting member being configured to be swingable in the width direction.

The present disclosure is directed to a terminal fitting with a connecting member and a protecting member configured such that the connecting member is arranged inside, wherein the protecting member includes a fulcrum portion, the connecting member is shaped to extend in a front-rear direction and includes a resiliently deformable resilient contact portion in a front part and a fulcrum receiving portion for receiving the fulcrum portion in a rear part, the resilient contact portion contacts a circuit board extending along a width direction, and the connecting member is swingable in the width direction with respect to the protecting member with the fulcrum portion as a fulcrum.

### Effect of the Invention

According to the present disclosure, it is possible to provide a connector and a terminal fitting capable of ensuring connection reliability with a circuit board.

### BRIEF DESCRIPTION OF THE DRAWINGS

FIG. 1 is an exploded perspective view of a connector.

FIG. 2 is a section showing a state where an inner housing is at an initial position with respect to an outer housing.

FIG. 3 is a section showing a state where the connector is connected to a mating connector and the inner housing is at a fitting position with respect to the outer housing.

FIG. 4 is a section showing a state where a connecting member is at a protection position with respect to a protecting member.

FIG. 5 is a section showing a state where the connecting member is at a connection position with respect to the protecting member.

FIG. 6 is a perspective view of the connecting member connected to a wire.

FIG. 7 is a perspective view of the protecting member.

FIG. 8 is an enlarged section showing a state where a fulcrum portion is arranged on a front end side of a fulcrum receiving portion when the connecting member is at the protection position.

FIG. 9 is a section along A-A of FIG. 8.

FIG. 10 is an enlarged section showing a state where the fulcrum portion is arranged on a rear end side of the fulcrum receiving portion when the connecting member is at the connection position.

FIG. 11 is a section along B-B of FIG. 10.

FIG. 12 is an enlarged section showing a state where a resilient contact portion is arranged inside the protecting member without swinging.

FIG. 13 is an enlarged section showing a state where the resilient contact portion is displaced to swing and a projection projects to outside through an opening.

### DETAILED DESCRIPTION TO EXECUTE THE INVENTION

### Description of Embodiments of Present Disclosure

First, embodiments of the present disclosure are listed and described.

(1) The connector of the present disclosure is provided with a housing, a circuit board to be arranged along a width direction in the housing, and a connecting member to be arranged in the housing and connected to the circuit board, the connecting member being configured to be swingable in the width direction. If the circuit board thermally expands with the connecting member and the circuit board connected, the connecting member is displaced to swing in the width direction, whereby a thermal expansion difference between the connecting member and the circuit board can be absorbed. As a result, a state where the connecting member is connected to the circuit board can be satisfactorily maintained.

(2) Preferably, the connecting member is arranged in the housing together with a protecting member, and the protecting member includes a fulcrum portion for a swinging motion of the connecting member. According to this configuration, the housing needs not be provided with the fulcrum portion and the complication of the structure of the housing can be avoided.

(3) The connecting member may be shaped to extend in a front-rear direction and include a resiliently deformable resilient contact portion in a front part and a fulcrum receiving portion for receiving the fulcrum portion behind the resilient contact portion, and the resilient contact portion may be configured to contact the circuit board. According to this configuration, a swing width of the connecting member can be adjusted by appropriately specifying a front-rear distance between the resilient contact portion and the fulcrum receiving portion.

(4) The protecting member may include a holding portion for holding the connecting member while allowing the swinging motion of the connecting member. According to this configuration, the connecting member and the protecting member can be integrally handled via the holding portion.

(5) The connecting member may be held movably to a protection position and a connection position with respect to the protecting member, and the resilient contact portion may be covered by the protecting member at the protection position and exposed from the protecting member to contact the circuit board at the connection position. According to this configuration, the resilient contact portion is protected by the protecting member when the connecting member is at the protection position. Thus, the resilient contact portion can be prevented from being damaged due to interference with external matters. A state where the resilient contact portion is in contact with the circuit board can be satisfactorily realized when the connecting member is at the connection position.

(6) The fulcrum receiving portion may be in the form of a rail extending in the front-rear direction, and the holding portion may be configured to abut on the connecting member from behind with the fulcrum portion arranged on a front end side of the fulcrum receiving portion. The holding portion abuts on the connecting member from behind, whereby the separation of the fulcrum portion from the fulcrum receiving portion can be prevented and, consequently, the connecting member can be prevented from coming out from the protecting member.

(7) The resilient contact portion may include a pair of projections protruding toward both sides in the width direction, the protecting member may include a pair of side wall portions on both sides in the width direction, openings may be open in the pair of side wall portions, and the projections may be arranged to face the side wall portions at the protection position and arranged to face the openings at the connection position. Since the projections are arranged to face the side wall portions when the connecting member is at the protection position, the resilient contact portion is arranged between the pair of side wall portions with a swinging motion restricted. On the other hand, since the projections are arranged to face the openings when the connecting member is at the connection position, the projections can enter the openings when the resilient contact portion swings. A swing range of the resilient contact portion can be expanded in the width direction by projecting amounts of the projections in the width direction, and a situation where the swing range cannot be secured due to the interference of the resilient contact portion with the side wall portions can be avoided.

(1) Further, the terminal fitting of the present invention is provided with a connecting member and a protecting member configured such that the connecting member is arranged inside, wherein the protecting member includes a fulcrum portion, the connecting member is shaped to extend in a front-rear direction and includes a resiliently deformable resilient contact portion in a front part and a fulcrum receiving portion for receiving the fulcrum portion behind the resilient contact portion, the resilient contact portion contacts a circuit board extending along a width direction, and the connecting member is swingable in the width direction with respect to the protecting member with the fulcrum portion as a fulcrum. According to this configuration, the connecting member swings in the width direction with respect to the protecting member, whereby a thermal expansion difference between the connecting member and the circuit board can be absorbed. As a result, a state where the connecting member is connected to the circuit board can be satisfactorily maintained. Further, the connecting member and the protecting member can be integrally handled as the terminal fitting.

(2) The connecting member may be held movably to a protection position and a connection position with respect to the protecting member, and the resilient contact portion may be covered by the protecting member at the protection position and exposed from the protecting member to contact the circuit board at the connection position. According to this configuration, when the connecting member is at the protection position, the resilient contact portion is protected by the protecting member. When the connecting member is at the connection position, a state where the resilient contact portion is in contact with the circuit board can be satisfactorily realized.

### Details of Embodiment of Present Disclosure

Specific examples of a connector and a terminal fitting of the present disclosure are described below with reference to the drawings. Note that the present invention is not limited to this illustration and is intended to be represented by claims and include all changes in the scope of claims and in the meaning and scope of equivalents.

### Basic Structure

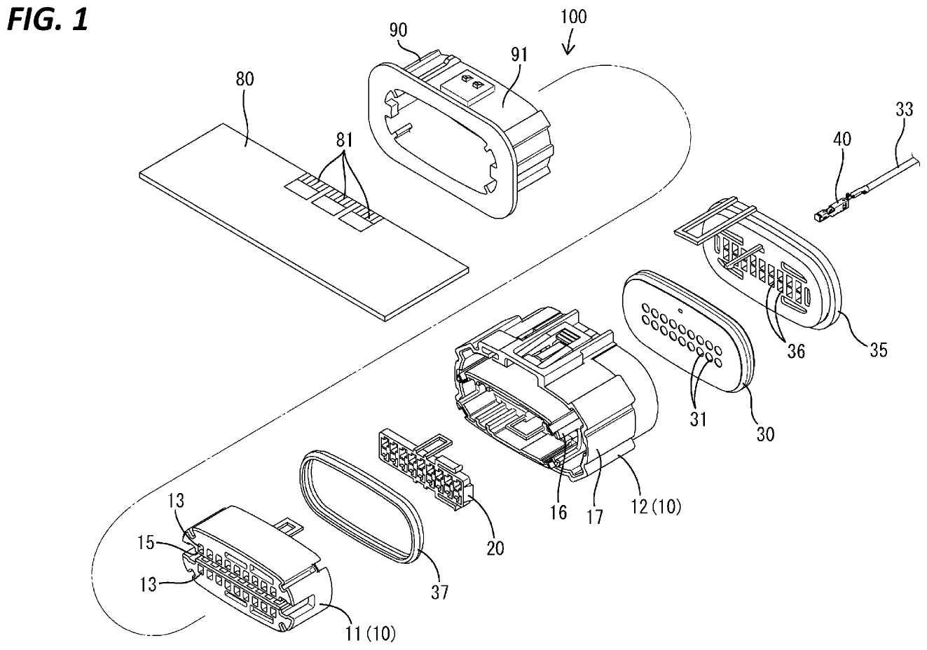

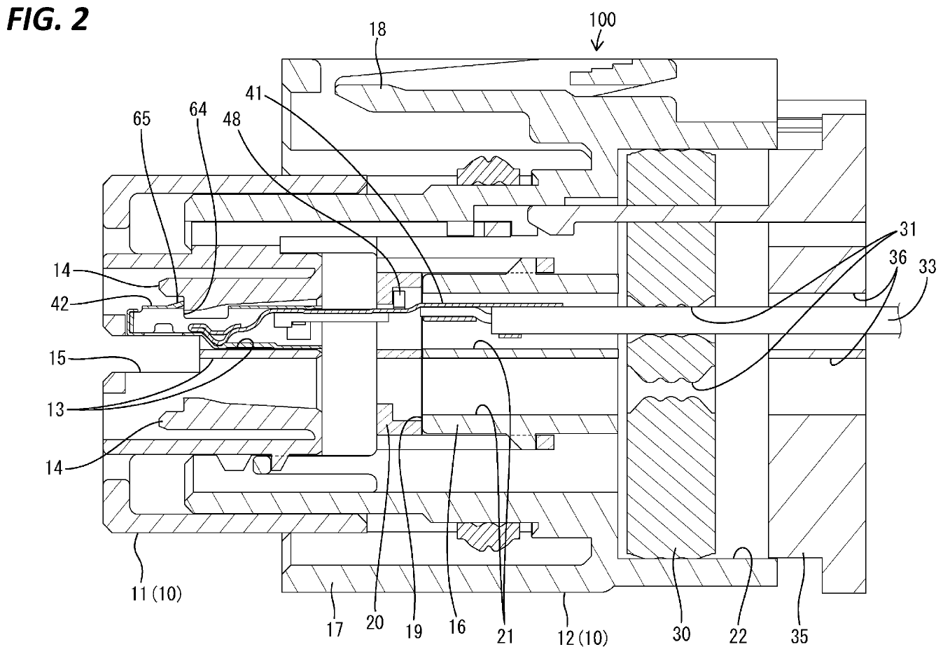

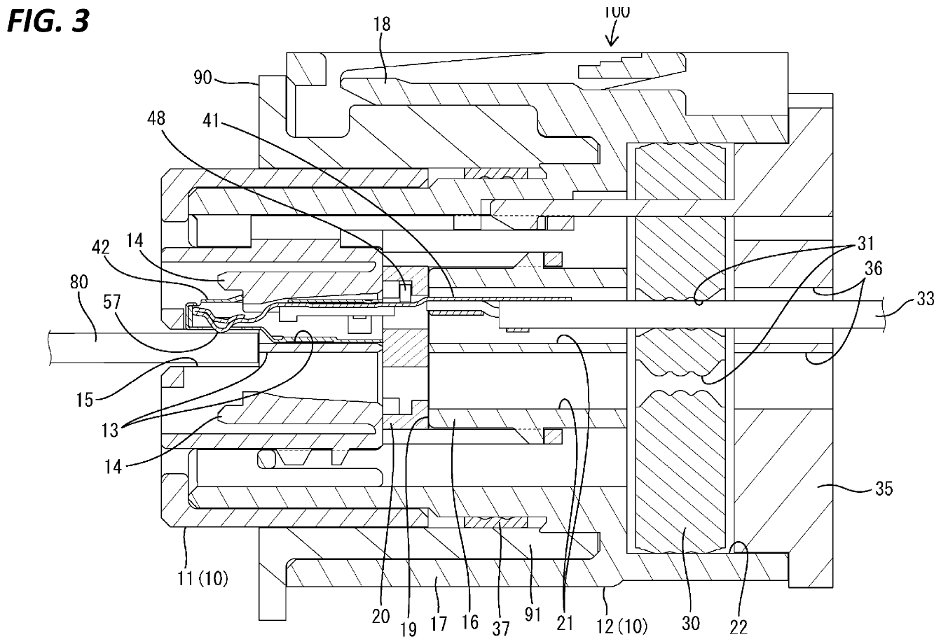

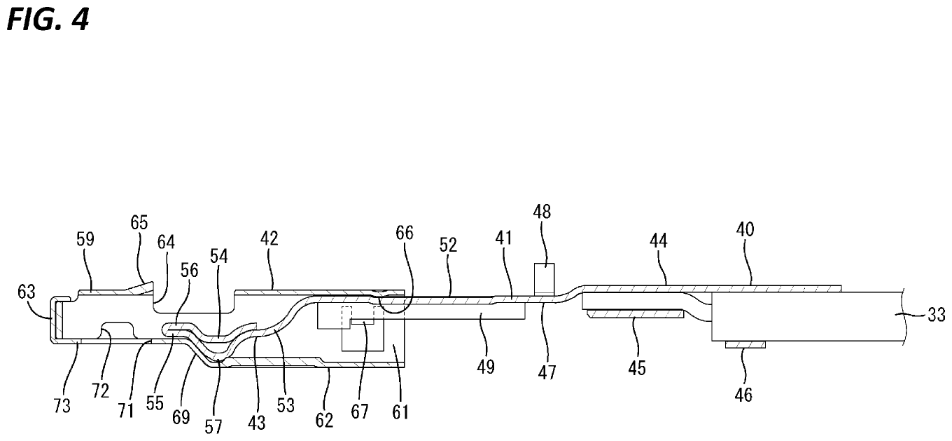

A connector 100 of the present disclosure includes a housing 10 and terminal fittings 40 as shown in FIG. 1. The housing 10 is made of synthetic resin and includes an inner housing 11 and an outer housing 12. The terminal fitting 40 is a plate member made of metal plate and includes, as shown in FIG. 4, a connecting member 41 and a protecting member 42. As shown in FIG. 2, the connecting member 41 is held in the outer housing 12. The protecting member 42 is held in the inner housing 11. As shown in FIG. 3, the housing 10 is connected to a mating connector 90. The mating connector 90 is fixed to an unillustrated case. A circuit board 80 is installed in the case. The connecting member 41 is electrically connected to the circuit board 80.

### Housing

As shown in FIG. 2, the housing 10 is configured by assembling the inner housing 11 in a front part of the outer housing 12. The inner housing 11 includes a plurality of front cavities 13. A plurality of front cavities 13 are arranged side by side in a width direction in each of two stages in a height direction.

The inner housing 11 includes a plurality of locking lances 14 at positions corresponding to the respective front cavities 13. Each locking lance 14 extends forward from an inner wall surface (upper surface of the front cavity 13 in the upper stage, lower surface of the front cavity 13 in the lower stage) of each front cavity 13, and a front end part thereof is shaped to project into the front cavity 13. The protecting member 42 is inserted into each front cavity 13. The protecting member 42 is resiliently locked by the locking lance 14 and held in the inner housing 11.

The inner housing 11 includes a board insertion portion 15 capable of accommodating the circuit board 80 in a central part between the respective upper and lower front cavities 13 in the height direction. As shown in FIG. 1, the board insertion portion 15 is in the form of a slit groove along the width direction and open in the front surface and both side surfaces of the inner housing 11. The board insertion portion 15 communicates with each of the upper and lower front cavities 13 in the inner housing 11.

The outer housing 12 includes a housing body 16 and a fitting tube portion 17 surrounding the outer periphery of the housing body 16. A sealing ring 37 is mounted on the outer periphery of the housing body 16. As shown in FIG. 3, a receptacle 91 of the mating connector 90 is fit between the fitting tube portion 17 and the housing body 16. The sealing ring 37 is sandwiched between the receptacle 91 and the housing body 16 to seal between the housing 10 and the mating connector 90 in a liquid-tight manner. A lock arm 18 is provided on the upper wall of the fitting tube portion 17. The lock arm 18 locks the receptacle 91 of the mating connector 90 and holds the housing 10 and the mating connector 90 in a fit state.

The housing body 16 includes an inner fitting portion 19 open in a front surface. The inner housing 11 is fittable to the inner fitting portion 19. The inner housing 11 is movable with the outer housing 12 to an initial position (see FIG. 2) where the inner housing 11 is lightly fit to the inner fitting portion 19 and a fitting position (see FIG. 3) which is relatively receded from the initial position and where the inner housing 11 is deeply fit to the inner fitting portion 19. A forward projecting amount of the inner housing 11 from the outer housing 12 decreases as the inner housing 11 moves from the initial position to the fitting position. Although not described in detail, the inner housing 11 and the outer housing 12 are provided with a lock structure for holding the inner housing 11 at the initial position and the fitting position.

As shown in FIG. 2, the housing body 16 includes a plurality of rear cavities 21 at positions communicating with the respective front cavities 13. A rear part of the connecting member 41 is inserted into the rear cavity 21.

Further, a retainer 20 is mounted in the housing body 16. The retainer 20 is arranged movably along the back surface (rear surface) of the inner fitting portion 19. The retainer 20 locks the connecting members 41. The connecting members 41 are held with forward and rearward movements with respect to the outer housing 12 restricted by the retainer 20.

A one-piece rubber plug 30 is mounted in a rear part of the housing body 16. The one-piece rubber plug 30 is made of rubber such as silicon rubber and accommodated into an accommodating portion 22 open in the rear surface of the housing body 16. The one-piece rubber plug 30 includes a plurality of sealing holes 31 at positions communicating with the respective rear cavities 21. A wire 33 connected to the connecting member 41 is inserted into each sealing hole 31 of the one-piece rubber plug 30 in a liquid-tight manner.

A rear holder 35 is accommodated into the accommodating portion 22 of the housing body 16, following the one-piece rubber plug 30. The rear holder 35 is held in the housing body 16. The one-piece rubber plug 30 is restricted from coming out from the accommodating portion 22 by the rear holder 35. The rear holder 35 includes a plurality of through holes 36 at positions communicating with the respective sealing holes 31. The wire 33 is inserted with play into each through hole 36 of the rear holder 35.

### Terminal Fittings

As shown in FIG. 4, the terminal fitting 40 is configured by arranging the protecting member 42 on a front part of the connecting member 41. The connecting member 41 is formed into a shape elongated in the front-rear direction by bending one metal plate.

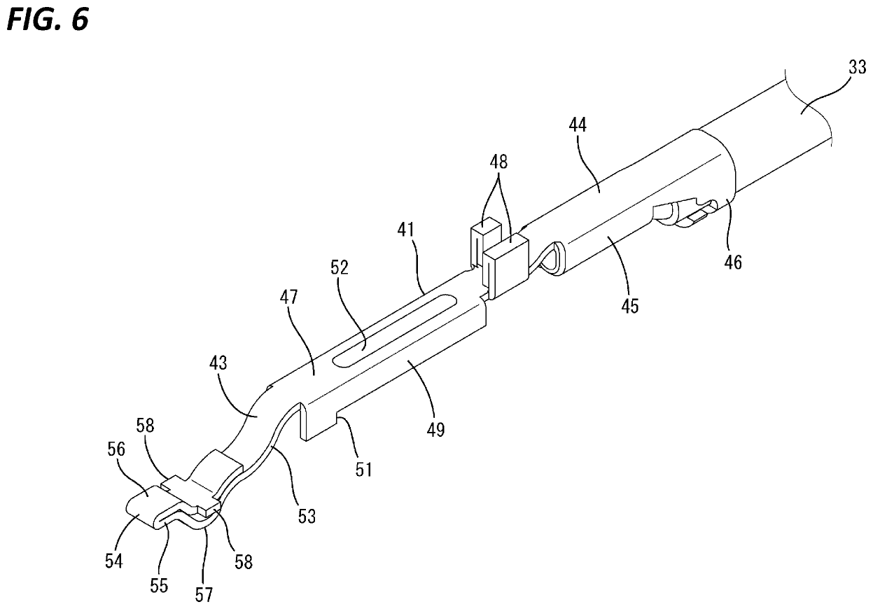

As shown in FIG. 6, the connecting member 41 includes a resilient contact portion 43 in a front part, a wire connecting portion 44 in a rear part and a base portion 47 between the resilient contact portion 43 and the wire connecting portion 44.

The wire connecting portion 44 includes a wire barrel portion 45 in a front part and an insulation barrel portion 46 in a rear part. The insulation barrel portion 46 is in the form of an open barrel and configured to have a shorter front-rear dimension than the wire barrel portion 45. The wire barrel portion 45 is in the form of an open barrel and crimped and connected to a conductor part (core) of the wire 33. The insulation barrel portion 46 is crimped and connected to an insulation coating of the wire 33.

The base portion 47 is in the form of a strip extending in the front-rear direction and having plate surfaces extending along the width direction. The connecting member 41 includes a pair of projecting pieces 48 projecting upward from both widthwise ends of a rear end part of the base portion 47. By locking the both projecting pieces 48 by the retainer 20, the connecting member 41 is held in the outer housing 12 (see FIGS. 2 and 3).

The connecting member 41 includes a pair of side portions 49 projecting downward from both widthwise ends of the base portion 47 in front of the both projecting pieces 48. The both side portions 49 are shaped to have plate surfaces extending along the height direction and extend in the front-rear direction. An intermediate part in the front-rear direction of the connecting member 41 has a gate-shaped cross-section by having the base portion 47 and the both side portions 49. As shown in FIG. 8, a front lower part of the side portion 49 projects long downward and the rear edge thereof is configured as a retained portion 51 capable of abutting on a retaining portion 68 to be described later.

As shown in FIGS. 6, 8 and 9, the connecting member 41 includes a rail-like fulcrum receiving portion 52 extending in the front-rear direction. The fulcrum receiving portion 52 is in the form of a bead bent downward in an intermediate part in the front-rear direction of the base portion 47. The fulcrum receiving portion 52 is in the form of a recessed groove extending in the front-rear direction while having a constant groove width and having a flat groove bottom in the upper surface of the base portion 47. A later-described fulcrum portion 66 of the protecting member 42 is arranged in the fulcrum receiving portion 52. The connecting member 41 is swingable in the width direction with the fulcrum portion 66 arranged in the fulcrum receiving portion 52 as a fulcrum.

As shown in FIG. 6, the resilient contact portion 43 includes a relay portion 53 curved from the front end of the base portion 47 and extending obliquely downward to the front. The resilient contact portion 43 includes a folded portion 54 in front of the relay portion 53. As shown in FIG. 4, the folded portion 54 is arranged lower than the side portions 49 via the relay portion 53. A lower plate portion 55 (outer plate part) and an upper plate portion 56 (inner plate part) are arranged side by side in the height direction in the folded portion 54.

The lower plate portion 55 includes a contact point portion 57 having a semicircular shape curved downward in a side view. The contact point portion 57 is curved and connected to the front end of the relay portion 53. The lower end of the contact point portion 57 electrically contacts a conductive portion 81 (see FIG. 1) of the circuit board 80. The upper plate portion 56 is shaped to extend rearward by being folded from the front end of the lower plate portion 55. As shown in FIG. 4, a front end part of the upper plate portion 56 and that of the lower plate portion 55 are arranged to overlap in the height direction. A rear end part of the upper plate portion 56 is overlapped on a rear end part of the contact point portion 57 and arranged to face the relay portion 53. An intermediate part in the front-rear direction of the upper plate portion 56 is arranged above and away from the contact point portion 57 between the front and rear end parts.

As shown in FIG. 6, the resilient contact portion 43 includes a pair of projections 58 protruding laterally (in the width direction) from both widthwise ends of the intermediate part in the front-rear direction of the upper plate portion 56. The both projections 58 are in the form of rectangular plates in a plan view and arranged at the same position as the lower end of the contact point portion 57 in the front-rear direction. The both projections 58 are arranged above and at a distance from the contact point portion 57 provided in the lower plate portion 55 by being provided on the upper plate portion 56.

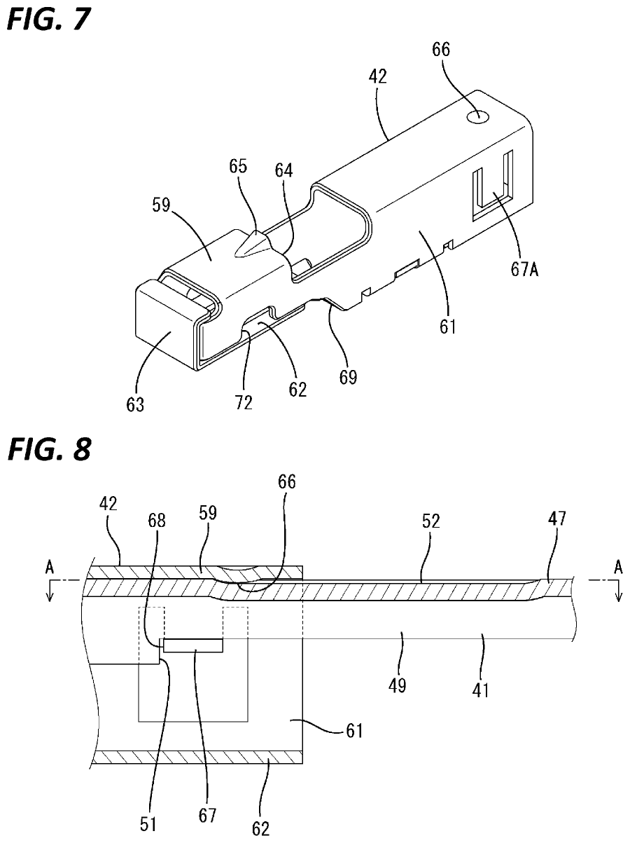

As shown in FIG. 7, the protecting member 42 is in the form of a box, particularly a rectangular tube, as a whole. A front part of the connecting member 41 is arranged inside the protecting member 42.

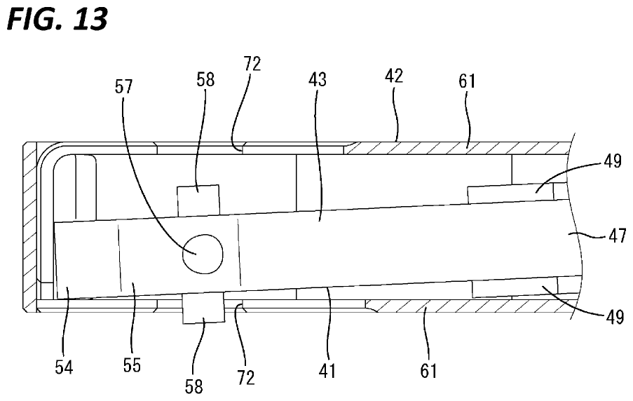

The protecting member 42 includes an upper wall portion 59 extending in the front-rear direction, a pair of side wall portions 61 projecting downward from both widthwise ends of the upper wall portion 59, a lower wall portion 62 projecting laterally from the lower ends of the side wall portions 61, and a front wall portion 63 projecting upward from the front end of the lower wall portion 62. Plate surfaces of the upper wall portion 59 and the lower wall portion 62 are arranged in parallel along the width direction. Plate surfaces of the both side wall portions 61 are arranged along the height direction. Plate surfaces of the front wall portion 63 are arranged along the height direction. As shown in FIGS. 4 and 12, the front wall portion 63 is a double wall by having wall parts projecting laterally from the front ends of the side wall portions 61.

As shown in FIG. 7, the upper wall portion 59 includes, in a front part, a lance hole 64 rectangular in a plan view and a locking projection 65 formed by bending the front edge of the lance hole 64 upward. As shown in FIG. 2, a front end part of the locking lance 14 enters the lance hole 64. The locking projection 65 is locked by the front end part of the locking lance 14.

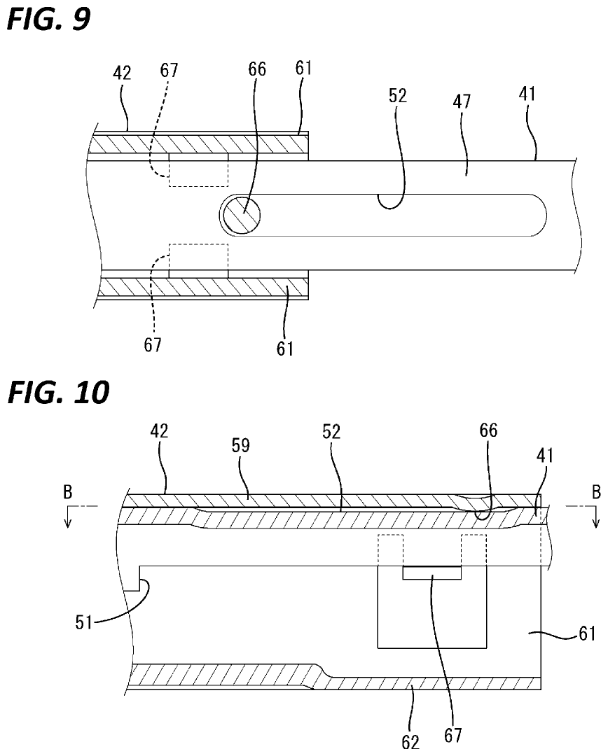

As shown in FIG. 7, the protecting member 42 includes the fulcrum portion 66 in a rear part of the upper wall portion 59. As shown in FIG. 8, the fulcrum portion 66 has an embossed shape projecting downward (inward) in a widthwise central part of a rear part of the upper wall portion 59. As shown in FIG. 9, the fulcrum portion 66 has a circular horizontal cross-sectional shape and has a diameter smaller than the groove width of the fulcrum receiving portion 52. The fulcrum portion 66 is arranged in the groove of the fulcrum receiving portion 52, displaceably in the front-rear direction.

The protecting member 42 includes a pair of holding portions 67 in rear parts of the both side wall portions 61. The both holding portions 67 are formed by making U-shaped cuts in the both side wall portions 61 and bending plate pieces 67A (see FIG. 7) inside the cuts inwardly. The both holding portions 67 are arranged along the width direction with the tips thereof facing each other. As shown in FIG. 8, the front end of the holding portion 67 serves as the retaining portion 68 and is arranged along the width direction.

As shown in FIG. 8, the both holding portions 67 are arranged to sandwich an intermediate part in the front-rear direction of the connecting member 41 between the facing upper wall portion 59 and the holding portions 67. The intermediate part in the front-rear direction of the connecting member 41 is held between the both holding portions 67 and the upper wall portion 59 while being allowed to move.

As shown in FIG. 4, the protecting member 42 includes a slope portion 69 inclined upward to the front at an intermediate position in the front-rear direction of the lower wall portion 62. A front part of the lower wall portion 62 serves as an upper stage portion 73 arranged higher than a rear part of the lower wall portion 62 via the slope portion 69. The upper stage portion 73 is provided with a connection hole 71 open in front of the slope portion 69. Further, the both side wall portions 61 are provided with a pair of openings 72 open at the same position as the connection hole 71 in the front-rear direction.

### Overall Structure and Connection Structure of Connector

In manufacturing the terminal fitting 40, the fulcrum portion 66 is inserted into the rear end side of the fulcrum receiving portion 52 and the both holding portions 67 are bent. In this way, the both holding portions 67 are arranged to abut on the both side portions 69 in the intermediate part in the front-rear direction of the protecting member 42 from below. The intermediate part in the front-rear direction of the connecting member 41 is loosely held between the upper wall portion 59 and the both holding portions 67. As shown in FIG. 4, when the connecting member 41 is at the protection position, the contact point portion 57 of the resilient contact portion 43 is arranged to be protected inside the upper wall portion 59, the both side wall portions 61 and the lower wall portion 62 behind the slope portion 69. Thus, the interference of external matters with the contact point portion 57 can be avoided. When the connecting member 41 is at the protection position, the tips of the both projections 58 are arranged to face the both side wall portions 61. In this way, a swinging motion of the connecting member 41 in the width direction at the protection position is restricted.

When the connecting member 41 is at the protection position, the retaining portions 68 are arranged to abut on the retained portions 51 from behind as shown in FIG. 8. In this way, the connecting member 41 is restricted from coming out rearward from the protecting member 42. Further, when the connecting member 41 is at the protection position, the contact point portion 57 is arranged to abut on the slope portion 69 from behind as shown in FIG. 4. In this way, the connecting member 41 is restricted from moving forward from the protection position.

The terminal fitting 40 in which the connecting member 41 and the protecting member 42 are integrated can be obtained in the above way.

Subsequently, each terminal fitting 40 is inserted into the housing 10. The inner housing 11 is held at an initial position with respect to the outer housing 12 before the insertion of the terminal fittings 40.

The protecting member 42 is inserted into the front cavity 13 through the through hole 36, the sealing hole 31 and the rear cavity 21 and, as shown in FIG. 2, retained by the locking lance 14. The connecting member 41 moves in the housing 10 together with the protecting member 42 and is retained by the retainer 20. A rear part of the connecting member 41 on the side of the wire connecting portion 44 is arranged in the rear cavity 21 and a front part thereof on the side of the resilient contact portion 43 is arranged in the front cavity 13 together with the protecting member 42. The connection hole 71 of the protecting member 42 is open to the board insertion portion 15 and the slope portion 69 is arranged to face the board insertion portion 15 from behind. Further, the wire 33 connected to the wire connecting portion 44 is inserted into the sealing hole 31 in a liquid-tight manner and pulled out to outside through the through hole 36.

Subsequently, the housing 10 is connected to the mating connector 90. In this way, as shown in FIG. 3, one end part of the circuit board 80 is inserted into the board insertion portion 15. The plate surfaces of the circuit board 80 are arranged along the width direction in the housing 10. Further, as the housing 10 is connected to the mating connector 90, a lock for holding the inner housing 11 and the outer housing 12 at the initial position is released and the outer housing 12 is enabled to move relatively forward with respect to the inner housing 11. As a connecting operation of the housing 10 proceeds, the inner housing 11 is deeply inserted to the inner fitting portion 19.

Here, the protecting members 42 are held in the inner housing 11 and the connecting members 41 are held in the outer housing 12. Thus, if the outer housing 12 and the inner housing 11 relatively approach each other, the connecting members 41 and the protecting members 42 also relatively approach each other to increase overlapping regions in the front-rear direction. In this way, the connecting members 41 become movable from the protection position toward the connection position with respect to the protecting members 42.

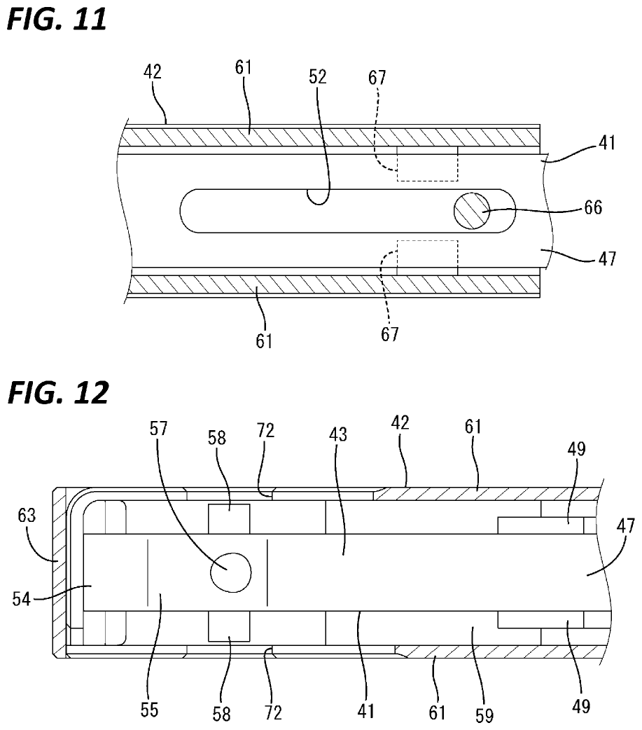

In a moving process of the connecting member 41, the contact point portion 57 slides on the slope portion 69 and the lower end of the contact point portion 57 temporarily rides on the upper stage portion 73 while the resilient contact portion 43 is deflected and deformed. Then, the fulcrum portion 66 is relatively displaced from a front end side toward a rear end side of the fulcrum receiving portion 52 (see FIGS. 9 and 11).

When the inner housing 11 reaches a fitting position with respect to the outer housing 12, the rear surface of the inner housing 11 is arranged to abut on the retainer 20. As the inner housing 11 reaches the fitting position, the connecting members 41 can also reach the connection position.

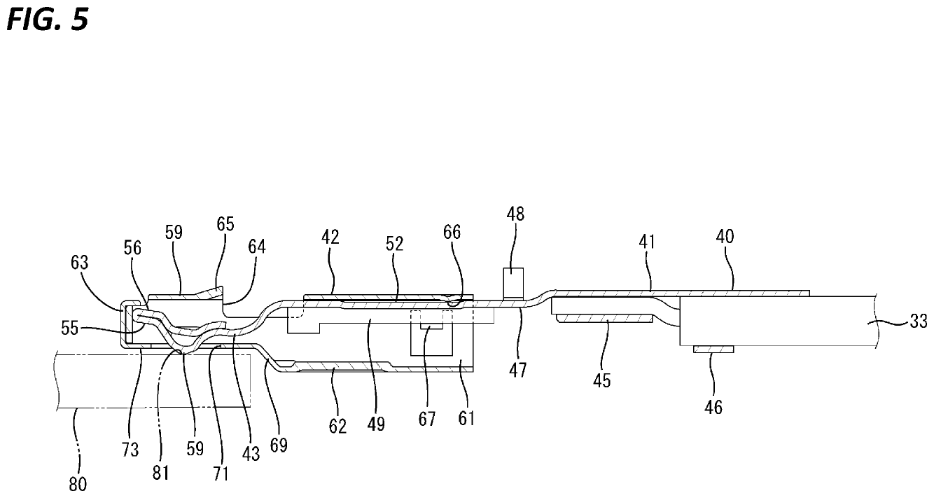

At the connection position, the contact point portion 57 falls down from the upper stage portion 73 and, as shown in FIG. 5, contacts the conductive portion 81 of the circuit board 80 arranged in the board insertion portion 15 through the connection hole 71. The resilient contact portion 43 is maintained in a deflected and deformed state. When the connecting member 41 is at the connection position, tip parts of the both projections 58 are arranged to face the openings 72 of the both side wall portions 61 as shown in FIG. 12.

The circuit board 80 may thermally expand and a width of the circuit board 80 may increase due to a factor such as the installation of the connector 100 at a high temperature. Here, although there is a thermal expansion difference between the connecting member 41 and the circuit board 80, the connecting member 41 can swing in the width direction with the fulcrum portion 66 as a fulcrum. Thus, the connecting member 41 can swing according to the thermal expansion of the circuit board 80 and can be displaced, following the circuit board 80. In this way, it can be avoided that an excessive stress (stress of deviation) is applied between the contact point portion 57 and the circuit board 80.

Particularly in the case of this embodiment, the projections 58 of the resilient contact portion 43 can enter the openings 72 when the connecting member 41 swings. Further, as shown in FIG. 13, the tip part of the projection 58 can project to the outside of the side wall portion 61 through the opening 72. Since the resilient contact portion 43 includes the projections 58 as just described, a large swing angle of the connecting member 41 can be set and it is possible to deal with a case where the circuit board 80 largely thermally expands in the width direction.

Further, the fulcrum portion 66 rotates in the groove of the fulcrum receiving portion 52 when the connecting member 41 swings. In this case, since the both holding portions 67 loosely hold the intermediate part in the front-rear direction of the connecting member 41, a friction resistance between the fulcrum portion 66 and the fulcrum receiving portion 52 does not become large and the connecting member 41 can smoothly swing.

As described above, according to this embodiment, even if the circuit board 80 thermally expands, the connecting member 41 is displaced to swing in the width direction, whereby a thermal expansion difference between the circuit board 80 and the connecting member 41 can be absorbed. As a result, a state where the connecting member 41 is connected to the conductive portion 81 of the circuit board 80 can be satisfactorily maintained.

Further, since the fulcrum portion 66 for the swinging motion of the connecting member 41 is provided in the protecting member 42, which is a part of the terminal fitting 40, the structure of the housing 10 needs not to be complicated.

Further, the connecting member 41 includes the resilient contact portion 43 in the front part and the fulcrum receiving portion 52 for receiving the fulcrum portion 66 behind the resilient contact portion 43. Thus, a swing width of the connecting member 41 can be adjusted by appropriately specifying a front-rear distance between the resilient contact portion 43 and the fulcrum receiving portion 52.

Further, the holding portions 67 of the protecting member 42 hold the connecting member 41 while allowing a swinging motion of the connecting member 41. Thus, even if the connecting member 41 and the protecting member 42 are structured to be relatively displaced, the connecting member 41 and the protecting member 42 can be integrally handled by a relatively simple structure.

Further, the resilient contact portion 43 of the connecting member 41 is covered and protected by the protecting member 42 at the protection position. Thus, the resilient contact portion 43 can be prevented from being damaged due to interference with external matters. As a result, a state where the resilient contact portion 43 is in contact with the circuit board 80 can be satisfactorily realized when the connecting member 41 is at the connection position.

Further, the retaining portions 68 of the holding portions 67 are configured to abut on the retained portions 51 of the connecting member 41 from behind with the fulcrum portion 66 of the protecting member 42 arranged on the front end side of the fulcrum receiving portion 52 of the connecting member 41. Thus, the separation of the fulcrum portion 66 from the fulcrum receiving portion 52 can be prevented and, consequently, the connecting member 41 can be prevented from coming out from the protecting member 42. Particularly, since the retaining portions 68 are merely provided on the front ends of the holding portions 67, the complication of the structure of the protecting member 42 can be avoided.

Further, the projections 58 of the resilient contact portion 43 are arranged to face the side wall portions 61 at the protection position and arranged to face the openings 72 at the connection position. The projections 58 can project to outside from the openings 72 at the connection position. Thus, a swing range of the resilient contact portion 43 can be expanded in the width direction by projecting amounts of the projections 58 in the width direction, and a situation where the swing range is restricted due to the interference of the resilient contact portion 43 with the side wall portions 61 can be avoided.

### Other Embodiments

The embodiment disclosed this time should be considered illustrative in all aspects, rather than restrictive.

Although the protecting member is provided in the terminal fitting in the case of the above embodiment, a protecting member may be provided in a housing as another embodiment.

Although the fulcrum portion is provided on the protecting member in the case of the above embodiment, a fulcrum portion may be provided on a component other than the protecting member such as a housing as another embodiment.

Although the protecting member is provided separately from the connecting member in the case of the above embodiment, a connecting member only has to be arranged swingably in a width direction in a housing and a connector may include no protecting member as another embodiment.

### LIST OF REFERENCE NUMERALS

10 . . . housing

11 . . . inner housing

12 . . . outer housing

13 . . . front cavity

14 . . . locking lance

15 . . . board insertion portion

16 . . . housing body

17 . . . fitting tube portion

18 . . . lock arm

19 . . . inner fitting portion

20 . . . retainer

21 . . . rear cavity

22 . . . accommodating portion

30 . . . one-piece rubber plug

31 . . . sealing hole

33 . . . wire

35 . . . rear holder

36 . . . through hole

37 . . . sealing ring

40 . . . terminal fitting

41 . . . connecting member

42 . . . protecting member

43 . . . resilient contact portion

44 . . . wire connecting portion

45 . . . wire barrel portion

46 . . . insulation barrel portion

47 . . . base portion

48. . . projecting piece

49 . . . side portion

51 . . . retained portion

52 . . . fulcrum receiving portion

53 . . . relay portion

54 . . . folded portion

55 . . . lower plate portion

56 . . . upper plate portion

57 . . . contact point portion

58 . . . projection

59 . . . upper wall portion

61 . . . side wall portion

62 . . . lower wall portion

63 . . . front wall portion

64 . . . lance hole

65 . . . locking projection

66 . . . fulcrum portion

67 . . . holding portion

67A . . . plate piece

68 . . . retaining portion

69 . . . slope portion

71 . . . connection hole

72 . . . opening

73 . . . upper stage portion

80 . . . circuit board

81 . . . conductive portion

90 . . . mating connector

91 . . . receptacle

100 . . . connector

1. A connector, comprising:
a housing;
a circuit board to be arranged along a width direction in the housing; and
a connecting member to be arranged in the housing and connected to the circuit board,
the connecting member being configured to be swingable in the width direction.

2. The connector of claim 1, wherein the connecting member is arranged in the housing together with a protecting member, and the protecting member includes a fulcrum portion for a swinging motion of the connecting member.

3. The connector of claim 2, wherein the connecting member is shaped to extend in a front-rear direction and includes a resiliently deformable resilient contact portion in a front part and a fulcrum receiving portion for receiving the fulcrum portion behind the resilient contact portion, and the resilient contact portion is configured to contact the circuit board.

4. The connector of claim 3, wherein the protecting member includes a holding portion for holding the connecting member while allowing the swinging motion of the connecting member.

5. The connector of claim 4, where the connecting member is held movably to a protection position and a connection position with respect to the protecting member, and the resilient contact portion is covered by the protecting member at the protection position and exposed from the protecting member to contact the circuit board at the connection position.

6. The connector of claim 5, wherein the fulcrum receiving portion is in the form of a rail extending in the front-rear direction, and the holding portion is configured to abut on the connecting member from behind with the fulcrum portion arranged on a front end side of the fulcrum receiving portion.

7. The connector of claim 5, wherein the resilient contact portion includes a pair of projections protruding toward both sides in the width direction, the protecting member includes a pair of side wall portions on both sides in the width direction, openings are open in the pair of side wall portions, and the projections are arranged to face the side wall portions at the protection position and arranged to face the openings at the connection position.

8. A terminal fitting, comprising:
a connecting member; and
a protecting member configured such that the connecting member is arranged inside,
wherein:
the protecting member includes a fulcrum portion, the connecting member is shaped to extend in a front-rear direction and includes a resiliently deformable resilient contact portion in a front part and a fulcrum receiving portion for receiving the fulcrum portion behind the resilient contact portion,
the resilient contact portion contacts a circuit board extending along a width direction, and
the connecting member is swingable in the width direction with respect to the protecting member with the fulcrum portion as a fulcrum.

9. The terminal fitting of claim 8, wherein the connecting member is held movably to a protection position and a connection position with respect to the protecting member, and the resilient contact portion is covered by the protecting member at the protection position and exposed from the protecting member to contact the circuit board at the connection position.
